(19) United States
(12) Patent Application Publication
(10) Pub. No.: US 2013/0137611 A1
(43) Pub. Date: May 30, 2013

(54) ADDITIVE COMPOSITION FOR WELL TREATMENT FLUIDS

(71) Applicant: Calfrac Well Services Ltd., Calgary (CA)

(72) Inventors: Ronald Pierce, Calgary (CA); Dwight Bobier, Calgary (CA)

(73) Assignee: CALFRAC WELL SERVICES LTD., Calgary (CA)

(21) Appl. No.: 13/687,318

(22) Filed: Nov. 28, 2012

(30) Foreign Application Priority Data
Nov. 28, 2011 (CA) 2759743

(51) Int. Cl. C09K 8/52; C09K 8/62; C09K 8/72; C09K 8/60

(52) U.S. Cl. CPC C09K 8/52; C09K 8/60; C09K 8/62; C09K 8/72
USPC 507/260

(57) ABSTRACT

Described is an additive composition made up of at least one dibasic ester, at least one non-ionic surfactant, at least one terpene or terpene derivative and optionally, at least one polyalkylene glycol and/or water. The composition is useful as an additive for well treatment fluids used for cleaning or stimulation of oil or gas wells.

### BACKGROUND OF THE INVENTION

The present application relates to additives for well treatment fluids used in the petrochemical industry. More specifically, well treatment fluids containing the present additives are useful in the stimulation or cleaning of wells or formations.

A variety of well treatment fluids can be used during the process of hydrocarbon recovery from subterranean formations, including cleanup fluids, completion fluids, injection fluids, fracturing fluids, and stimulation fluids including acid fluids. Such fluids can be aqueous or water-based, or based on organic fluids such as methanol or hydrocarbons, depending upon the desired application. However, aqueous fluids have a limited ability to dissolve hydrophobic residues such as oil and tar, and organic fluids, especially hydrocarbon fluids, can have a low miscibility with water or aqueous fluids which may be present in the wellbore or the formation. Well treatment fluids may contain additives which facilitate the removal of undesired residues such as solid debris, oily or tarry deposits, or residual water or aqueous fluids from the wellbore or formation pores so as to allow improved flow of oil or gas from the well. However, such additives often include toxic or flammable materials, such as xylene, toluene, ketones, or ethylene glycol monobutyl ether (EGMBE).

Microemulsions are thermodynamically stable, single phase mixtures comprising an aqueous fluid, a hydrophobic fluid normally immiscible with the aqueous fluid, and one or more surfactants. Microemulsions can appear macroscopically homogeneous and optically clear, even if heterogeneous at a microscopic level, and can have significantly lower interfacial surface tensions than ordinary oil/water emulsions. Such microemulsions have the capacity to solubilize both hydrophilic and hydrophobic substances, and have therefore found many applications in the cleaning, food, cosmetic, agrochemical, biotechnology, pharmaceutical, petrochemical and other industries. For example, such applications are described in U.S. Pat. Nos. 7,380,606, 7,902,123 and 7,989,404, and in US Patent Application Publication No. 2009/0281012.

A known method of preparing microemulsions is the addition of a lower alcohol as a co-surfactant to an oil/water emulsion so as to lower the interfacial surface tension of the emulsion. However, such alcohols can be toxic or flammable, making microemulsions containing such alcohols less desirable for use.

Therefore, there is a need for a well treatment fluid additive which can address one or more of the disadvantages of current additives.

### SUMMARY OF THE INVENTION

In one aspect, the present application is directed to an additive composition for a well treatment fluid, wherein the additive composition contains at least one dibasic ester, at least one non-ionic surfactant and at least one terpene or terpene derivative. Optionally, the additive composition additionally contains at least one polyalkylene glycol and/or water. In at least one embodiment, the additive composition comprises about 30% to about 60% of the at least one dibasic ester, about 30% to about 60% of the at least one non-ionic surfactant, about 1% to about 15% of the at least one terpene or terpene derivative, no more than about 20% water by volume and no more than about 5% of the at least one polyalkylene glycol. In at least one embodiment, the additive composition is effective to increase the solubility of at least one of an aqueous material or a hydrophobic material in the well treatment fluid compared to the solubility of the aqueous material or the hydrophobic material in the well treatment fluid which is free from the additive composition. in at least one embodiment, the additive composition is effective to form a microemulsion with an aqueous fluid.

In another aspect, the present application is directed to a well treatment fluid comprising an additive composition as described herein.

### BRIEF DESCRIPTION OF THE DRAWINGS

Further features of the present invention will become apparent from the following written description and the accompanying figures, in which:

FIG. 1A is a photograph of a flask containing water to which has been added a first embodiment of an additive composition according to the present application at a concentration of 2 L/m³;

FIG. 1B is a photograph of a flask containing water to which has been added a second embodiment of an additive composition according to the present application at a concentration of 2 L/m³;

FIG. 2A is a photograph of a flask containing diesel fluid to which has been added the embodiment of FIG. 1A at a concentration of 2 L/m³; and

FIG. 2B is a photograph of a flask containing diesel fluid to which has been added the embodiment of FIG. 1B at a concentration of 2 L/m³.

### DETAILED DESCRIPTION OF THE INVENTION

The present additive composition contains at least one dibasic ester, at least one non-ionic surfactant, at least one terpene or terpene derivative and optionally at least one polyalkylene glycol and/or water. In at least one embodiment, the additive composition contains about 30% to about 60% of the at least one dibasic ester, about 30% to about 60% of the at least one non-ionic surfactant, about 1% to about 15% of the at least one terpene or terpene derivative, no more than about 20% water by volume and no more than about 5% of the at least one polyalkylene glycol. As used herein and unless specified otherwise, all percentage values are percentage values by weight (w/w)

In at least one embodiment, the at least one dibasic ester has the structural formula:

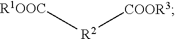

wherein R¹ and R³ are each independently selected from (C₁₋₂₀)alkyl, (C₃₋₁₀)cycloalkyl, aryl, (C₁₋₁₂)alkylaryl and aryl(C₁₋₁₂)alkyl; and R² is —(CH₂)ₚ—, wherein p is an integer from 2 to 7, and wherein the —(CH₂)ₚ— group is optionally substituted with from 1 to 3 (C₁₋₃)alkyl groups.

In at least one embodiment, R¹ and R³ are each independently a (C₁₋₁₂)alkyl group. In at least one embodiment, R¹ and R³ are each independently a (C₁₋₈)alkyl group. In at least one embodiment, R¹ and R³ are each independently a (C₁₋₆)alkyl group. In at least one embodiment, R¹ and R³ are each independently selected from methyl, ethyl, propyl, 1-methylethyl, butyl, 2-methylpropyl, pentyl, 3-methylbutyl, hexyl, cyclohexyl, heptyl, octyl and 2-ethylhexyl. In at least one embodiment, R¹ and R³ are each independently selected from methyl, ethyl, propyl, 1-methylethyl, butyl, 2-methylpropyl, pentyl and 3-methylbutyl. In at least one embodiment, R¹ and R³ are each independently selected from a hydrocarbon group originating from an alcohol found in fusel oil. In at east one embodiment, R² is —(CH₂)ₚ—, wherein p is 2, 3 or 4, and the —(CH₂)ₚ— group is optionally substituted with from 1 to 3 (C₁₋₃)alkyl groups,

hi at least one embodiment, the at least one dibasic ester is selected from one or more of a di(C₁₋₈)alkyl succinate, a di(C₁₋₈)alkyl glutarate, a di(C₁₋₈)alkyl adipate, and a mixture thereof, each of which can be further substituted on the succinate, glutarate or adipate portions with from 1 to 3 (C₁₋₃)alkyl groups. In at least one embodiment, the at least one dibasic ester is selected from one or more of a di(C₁₋₆)alkyl ethylsuccinate, a di(C₁₋₆)alkyl methylglutarate, a di(C₁₋₆)alkyl adipate, and a mixture thereof. In at least one embodiment, the at least one dibasic ester is selected from one or more of a dimethyl ethylsuccinate, a diethyl ethylsuccinate, a dimethyl methylglutarate, a diethyl methylglutarate, a dimethyl adipate, a diethyl adipate, and a mixture thereof. In at least one embodiment, the at least one dibasic ester is selected from one or more of dimethyl ethylsuccinate, diethyl ethylsuccinate, dimethyl 2-methylglutarate, diethyl 2-methylglutarate, dimethyl 3-methylglutarate, diethyl 3-methylglutarate, dimethyl adipate, diethyl adipate, and a mixture thereof. In at least one embodiment, the at least one dibasic ester is dimethyl 2-methylglutarate.

The term “substituent”, as used herein and unless specified otherwise, is intended to mean an atom, radical or group which may be bonded to a carbon atom, a heteroatom or any other atom which may form part of a molecule or fragment thereof, which would otherwise be bonded to at least one hydrogen atom. Substituents contemplated in the context of a specific molecule or fragment thereof are those which give to chemically stable compounds, such as are recognized by those skilled in the art.

The terms “alkyl” or “(C₁₋ₙ)alkyl” as used herein and unless specified otherwise, wherein n is an integer, either alone or in combination with another radical, are intended to mean an acyclic, straight or branched chain, saturated alkyl radical containing from 1 to n carbon atoms, wherein n is an integer. “Alkyl” includes, but is not limited to, methyl, ethyl, propyl(n-propyl), butyl(n-butyl), 1-methylethyl(iso-propyl), 1-methylpropyl(sec-butyl), 2-methylpropyl (iso-butyl), 1,1-dimethylethyl(tert-butyl), pentyl(n-pentyl), hexyl(n-hexyl), octyl (n-octyl), decyl(n-decyl), isodecyl(8-methylnonyl), dodecyl(n-dodecyl), and tetradecyl(n-tetradecyl).

The terms “cycloalkyl” or “(C₃₋ₘ)cycloalkyl” as used herein and unless specified otherwise, wherein m is an integer, either alone or in combination with another radical, are intended to mean a saturated cycloalkyl substituent containing from 3 to m carbon atoms, wherein m is an integer, and includes, but is not limited to, cyclopropyl, cyclobutyl, cyclopentyl, cyclohexyl and cycloheptyl.

The term “aryl” as used herein and unless specified otherwise, either alone or in combination with another radical, is intended to mean a carbocyclic aromatic monocyclic group containing 6 carbon atoms which may be further fused to one or more 5- or 6-membered carbocyclic groups, each of which may be aromatic, saturated or unsaturated. “Aryl” includes, but is not limited to, phenyl, indanyl, indenyl, 1-naphthyl, 2-naphthyl, tetrahydronaphthyl and dihydronaphthyl.

The terms “arylalkyl” or “aryl(C₁₋ₙ)alkyl” as used herein and unless specified otherwise, wherein n is an integer, either alone or in combination with another radical, are intended to mean a saturated, acyclic alkyl radical having 1 to n carbon atoms as defined above which is itself substituted with an aryl radical as defined above. Examples of arylalkyl include, but are not limited to, phenylmethyl (benzyl), 1-phenylethyl, 2-phenylethyl and phenylpropyl.

The terms “alkylaryl” or “(C₁₋ₙ)alkylaryl” as used herein and unless specified otherwise, wherein n is an integer, either alone or in combination with another radical, are intended to mean an aryl radical as defined above which is itself substituted with one or more saturated, acyclic alkyl radicals each having 1 to n carbon atoms as defined above. Examples of alkylaryl include, but are not limited to, 2-methylphenyl, 3-methylphenyl, 4-methylphenyl, 2-ethylphenyl, 3-ethylphenyl, 4-ethylphenyl, 2,3-dimethylphenyl, and the like.

Methods for the preparation of the at least one dibasic ester of the present additive composition are described in U.S. Patent Application Publication 2009/0281012, For example, the at least one dibasic ester of the present additive composition can be prepared from one or more dinitrile precursors, by methods well known in the art. In at least one embodiment, the one or more dinitrile precursors can be a mixture of dinitriles formed in the industrial process for the manufacture of adiponitrile by double hydrocyanation of butadiene. Such a mixture of dinitriles includes at least one of adiponitrile, methylglutaronitrile and ethylsuccinonitrile. In addition, the at least one dibasic ester of the present additive composition can be prepared from one or more by-products in the reaction, synthesis and/or production of adipic acid used in the production of polyamide, including but not limited to polyamide 6,6.

In at least one embodiment, the at least one non-ionic surfactant is at least one aliphatic alkoxylated alcohol. In at least one embodiment, the at least one aliphatic alkoxylated alcohol is at least one ethoxylated alcohol of the formula:

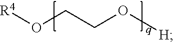

wherein R⁴ is a (C₅₋₂₅)alkyl group which is branched or linear; and q is an integer from 1 to about 30. In at least one embodiment, R⁴ is a (C₆₋₁₆)alkyl group which is branched or linear. In at least one embodiment, R⁴ is a (C₈₋₁₃)alkyl group which is branched or linear. In at least one embodiment, q is an integer from about 2 to about 20. In at least one embodiment, q is an integer from about 3 to about 12. In at least one embodiment, the ethoxylated alcohol s an ethoxylated isodecyl alcohol.

In at least one embodiment, the at least one non-ionic surfactant has an HLB number between about 7 and about 15. As is well understood in the art, the term “HLB number” or “Hydrophile-Lipophile Balance number” is a measure of the hydrophobicity or hydrophilicity of a non-ionic surfactant, or its affinity for water or oil. Surfactants with higher HLB numbers (for example, greater than 10) have a relatively greater affinity for water, and are more hydrophilic, while those with lower HLB numbers (for example, less than 10) have a relatively greater affinity for oil and are more lipophilic.

In at least one embodiment, the at least one terpene is selected from pinene and limonene, including stereoisomers, enantiomers and racemates thereof and mixtures thereof. Pinene includes but is not limited to the structural isomers α-pinene and β-pinene, including stereoisomers, enantiomers and racemates thereof and mixtures thereof. In at least one embodiment, the terpene is α-pinene, β-pinene, (+)-limonene or mixtures thereof. In at least one embodiment, the terpene derivative is a terpene alkoxylate having the formula

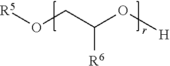

wherein R⁵ is a terpenyl radical, R⁶ is independently in each instance H or a (C₁₋₃)alkyl group, and r is an integer of from about 1 to about 50. In at least one embodiment, R⁵ is a pinenyl radical or a limonenyl radical. In at least one embodiment, R⁵ is an α-pinenyl radical, a β-pinenyl radical or a (+)-limonenyl radical. In at least one embodiment, R⁶ is independently in each instance H or CH₃. In at least one embodiment, the terpene alkoxylate is an ethoxyl propoxyl terpene.

In at least one embodiment, the additive composition further comprises no more than about 5% of a polyalkylene glycol. In at least one embodiment, the polyalkylene glycol is selected from polyethylene glycol and polypropylene glycol. In at least one embodiment, the polyalkylene glycol is polyethylene glycol. In at least one embodiment, when the additive composition comprises up to about 5% of a polyalkylene glycol, the additive composition has a reduced tendency to become cloudy.

In at least one embodiment, the additive composition comprises about 30% to about 60% of at least one dibasic ester; about 30% to about 60% of at least one aliphatic ethoxylated alcohol; about 1% to about 15% of at least one terpene; and no more than 5% polyethylene glycol. In at least one embodiment, the additive composition comprises about 30% to about 60% of ethoxylated isodecyl alcohol; about 30% to about 60% of at least one dibasic ester selected from one or more of a di(C₁₋₆)alkyl ethylsuccinate, a di(C₁₋₆)alkyl methylglutarate, a di(C₁₋₆)alkyl adipate and mixtures thereof; about 1% to about 15% of at least one terpene selected from pinene, (+)-limonene and mixtures thereof; and no more than 5% polyethylene glycol.

In at least one embodiment, the additive composition comprises about 30% to about 60% of at least one dibasic ester; about 30% to about 60% of at least one aliphatic ethoxylated alcohol; about 5% to about 10% of at least one ethoxyl propoxyl terpene; and no more than 5% polyethylene glycol. In at least one embodiment, the additive composition comprises about 30% to about 60% of ethoxylated isodecyl alcohol; about 30% to about 60% of dimethyl 2-methylglutarate; about 5% to about 10% of at least one ethoxyl propoxyl terpen and no more than 5% polyethylene glycol. Suitable additive compositions include but are not limited to Rhodiasolv™ Infinity (Rhodia).

In at least one embodiment, the additive composition is a microernulsion additionally comprising from bout 1% to about 20% water by volume. In at least one embodiment, the additive composition additionally comprises from about 2% to about 20% water by volume. In at least one embodiment, the additive composition additionally comprises from about 12% to about 20% water by volume. In at least one embodiment, the additive composition additionally comprises about 12% water by volume.

The present additive compositions are useful as additives in well treatment fluids, including but not limited to well cleanup fluids, fracturing fluids, injection fluids and acid stimulation fluids. In at least one embodiment, the present additive composition can be added to water-based well treatment fluids and to organic-based well treatment fluids, including but not limited to methanol-based fluids or hydrocarbon-based fluids. In embodiments where the additive composition comprises from about 12% to about 20% water by volume, the additive composition is particularly useful as an additive in aqueous or water-based well treatment fluids. In at least one embodiment, a well treatment fluid can contain from about 0.05% to about 1.0% by volume of the present additive composition.

In at least one embodiment, the additive-containing well treatment fluid can be prepared by adding the additive composition to a well treatment fluid. In at least one embodiment, the additive composition can be added to the well treatment fluid on-site prior to introducing the additive-containing well treatment fluid into the well. In at least one embodiment, when the additive composition contains from about 12% to about 20% water by volume, the additive composition has a reduced freeze point compared to the additive which contains no more than 1% water by volume. In at least one embodiment, when the additive composition contains about 12% water by volume, the freeze point of the additive composition is reduced to less than −20° C. or to less than −30° C. Reducing the freeze point of the additive composition facilitates the addition of the additive composition to the well treatment fluid on-site during conditions when the ambient temperature is at or below 0° C., since the additive composition can remain fluid under such conditions. In addition, in at least one embodiment, the present additive compositions have at least one of the properties of being environmentally friendly, biodegradable, non-toxic, or non-flammable. In at least one embodiment, the additive composition has a flash point higher than 140° C.

In at least one embodiment, the additive composition can form a microemulsion with a water-based well treatment fluid. Such a microemulsion can aid in dissolving and removing hydrophobic, oily or tarry residues within the formation which would otherwise be insoluble in the water-based well treatment fluid not containing the additive composition. Furthermore, in at least one embodiment, the present additive composition will readily mix with organic-based well treatment fluids. When added to an organic-based well treatment fluid, the additive composition is effective, in at least one embodiment, to promote microemulsion formation between the organic-based well treatment fluid and water or aqueous fluids. Thus, for example, when organic-based well treatment fluids containing the present additive composition are introduced into a formation previously treated with aqueous fluids, the well treatment fluid can mix with the residual aqueous fluid and act to remove it from the formation. Furthermore, organic-based well treatment fluids containing the present additive composition can act to remove residual water from a formation.

Well cleanup and completion fluids are used to clean debris and residue, including but not limited to residual water-based, oil-based and invert emulsion-based drilling muds, from the formation after drilling the wellbore so that the well can be completed and prepared for production. Well cleanup and completion fluids are often water-based or brine-based, and include but are not limited to preflush fluids, spacer fluids and tubular wash fluids. Adding the present additive composition to an aqueous well cleanup fluid can improve the cleaning performance by allowing sticky oil, tar and other hydrophobic residue to be cleaned from solid debris and from the wellbore, allowing the debris to be more readily removed from the wellbore. In addition, the removal of residual water-based, oil-based and invert-based drilling muds from the wellbore when drilling is completed can be facilitated by well cleanup and completion fluids containing the additive composition.

Fracturing fluids are used to stimulate hydrocarbon production from a formation by opening formation cracks and pores so as to increase the oil or gas flow. Suitable fracturing fluids can be based on water, hydrocarbons, methanol or mixtures thereof. Fracturing fluids containing additive compositions as described herein can show improved solubility of aqueous or water residues and/or hydrophobic oily or tarry residues, thereby facilitating entry of the fracturing fluid into the formation.

Injection fluids are injected into formations to stimulate hydrocarbon production by forcing hydrocarbons from reservoirs in the formation out into the wellbore. Suitable injection fluids can be based on water, hydrocarbons, methanol or mixtures thereof. Injection fluids containing additive compositions as described herein can have improved solubility of aqueous or water residues and/or hydrophobic oily or tarry residues, thereby facilitating entry into the formation and displacement of the oil or gas from reservoirs.

Acid stimulation fluids are used to stimulate well production by cleaning acid-soluble residues such as mineral scale from the wellbore and formation pores, thereby opening pores and allowing a freer flow of the oil or gas from the formation. Acid stimulation fluids can be aqueous, and include but are not limited to fluids having a pH of no more than 4. Such fluids can contain organic or inorganic acids, including but not limited to hydrochloric acid, acetic acid and formic acid. Adding the present additive composition to an acid stimulation fluid can allow the removal of hydrophobic residues which may also be present in the formation, allowing the acidic fluid to form better contact with the scale or mineral deposits to be dissolved.

### EXAMPLES

Other features of the present invention will become apparent from the following non-limiting examples which illustrate, by way of example, the principles of the invention. It will be apparent to a person of skill in the art that the procedures exemplified below may be used, with appropriate modifications, to prepare other additive compositions of the invention as described herein.

Additive compositions according to the present invention are prepared as follows: Additive composition A is Rhodiasolv™ Infinity (commercially available from Rhodia). This composition is determined to contain 1% water by volume by Karl Fischer titration. Additive composition B is prepared by combining Rhodiasolv™ Infinity with water treated by reverse osmosis, so that the final composition contains 12% water by volume.

### Freeze/Pour Temperature

The freeze/pour temperature of the additive composition can be measured by the following procedure. A sample of the additive composition (10 mL) is placed into a freezer at 0° C. for four hours, then observed. If the sample appears to be fluid when tilted, the temperature of the freezer is decreased by 5 Celsius degrees and the sample returned to the freezer for an additional 4 hours. Observation of the sample at 4 hour intervals with decrease of the freezer temperature by 5 Celsius degree increments after each observation are continued until the sample no longer appears fluid when tilted.

When measured using this procedure, the freeze/pour temperature of additive composition B was determined to be below −30° C. In comparison, the freeze/pour temperature of additive composition A was measured as 0° C.

### Solubility

The qualitative solubility of the additive composition in various fluids can be determined by adding the additive composition (0.2 mL) to a test fluid (100 mL) in a clear glass flask, stirring the mixture for 1 minute with a magnetic stir rod and observing the homogeneity of the mixture.

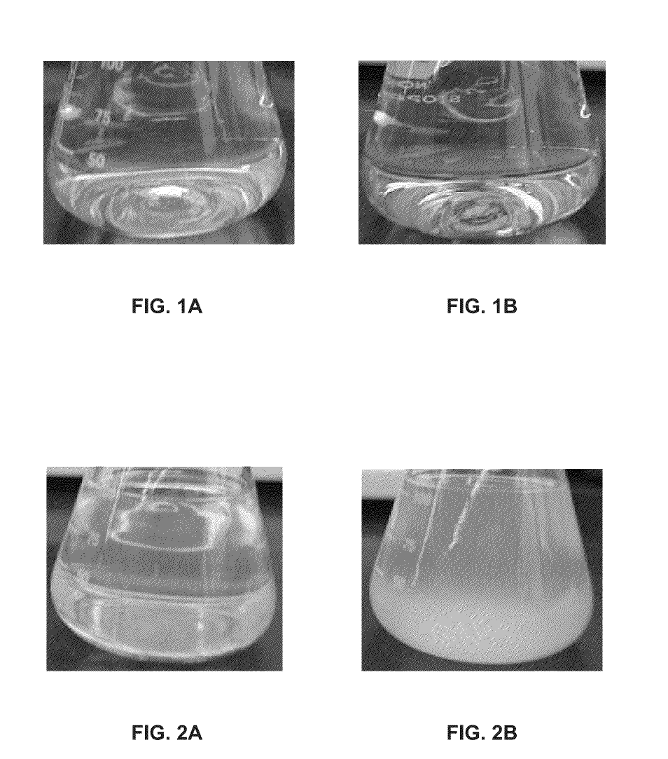

As seen in FIG. 1A, a mixture of water and additive composition A at a concentration of 2 L/m³ appears clear and homogeneous, as does a mixture of water and additive composition B at a concentration of 2 L/m³ (FIG. 1B). In addition, a mixture of diesel fluid and additive composition A at a concentration of 2 L/m³ appears homogeneous but slightly cloudy (FIG. 2A), while a mixture of diesel fluid and additive composition B at a concentration of 2 L/m³ appears slightly more cloudy (FIG. 2B).

The embodiments described herein are intended to be illustrative of the present compositions and methods and are not intended to limit the scope of the present invention. Various modifications and changes consistent with the description as a whole and which are readily apparent to the person of skill in the art are intended to be included. The appended claims should not be limited by the specific embodiments set forth in the examples, but should be given the broadest interpretation consistent with the description as a whole.

What is claimed is:

1. An additive composition for a well treatment fluid, the additive composition comprising:
about 30% to about 60% by weight of at least one dibasic ester;
about 30% to about 60% by weight of at least one non-ionic surfactant;
about 1% to about 15% by weight of at least one terpene or terpene derivative;
no more than about 20% by volume of water; and
no more than about 5% by weight of at least one polyalkylene glycol.

2. The additive composition according to claim 1 wherein the additive composition is effective to increase the solubility of at least one of an aqueous material or a hydrophobic material in the well treatment fluid compared to the solubility of the aqueous material or the hydrophobic material in the well treatment fluid which is free from the additive composition.

3. The additive composition according to claim 1 wherein the additive composition is effective to form a microemulsion with an aqueous fluid.

4. The additive composition according to claim 1 wherein the at least one dibasic ester is selected from a di(C₁₋₆)alkyl ethylsuccinate, a di(C₁₋₆)alkyl methylglutarate, a di(C₁₋₆)alkyl adipate, and a mixture thereof.

5. The additive composition according to claim 4 wherein the at least one dibasic ester is dimethyl 2-methylglutarate.

6. The additive composition according to claim 1 wherein the at least one non-ionic surfactant is at least one aliphatic alkoxylated alcohol.

7. The additive composition according to claim 6 wherein the at least one aliphatic alkoxylated alcohol is ethoxylated isodecyl alcohol having a Hydrophile-Lipophile Balance (HLB) number between about 7 and about 15.

8. The additive composition according to claim 1 wherein the at least one terpene or terpene derivative is selected from pinene and limonene.

9. The additive composition according claim 1 wherein the at least one terpene or terpene derivative is an ethoxyl propoxyl terpene.

10. The additive composition according to claim 1 wherein the at least one polyalkylene glycol is polyethylene glycol.

11. The additive composition according to claim 1 comprising about 12% water by volume.

12. A method of preparing a well treatment fluid comprising the additive composition as defined in claim 1, the method comprising adding the additive composition to the well treatment fluid.

13. A well treatment fluid comprising the additive composition as defined in claim 1.

14. The well treatment fluid according to claim 13 comprising from about 0.05% to about 1.0% by volume of the additive composition.

15. The well treatment fluid according to claim 13 which is a fracturing fluid.

16. The well treatment fluid according to claim 13 which is an injection fluid.

17. The well treatment id according to claim 13 which is an acid stimulation fluid.

18. The well treatment fluid according to claim 13 which is a well cleanup fluid,
